(19) United States
(12) Patent Application Publication
(10) Pub. No.: US 2004/0228448 A1
(43) Pub. Date: Nov. 18, 2004

(54) X-ray beam emission window for vacuum tubes

(76) Inventors: Peter Rother, Baiersdorf (DE); Peter Schardt, Hochstadt (DE); Jutta Rother, Baiersdorf (DE)

Correspondence Address: SCHIFF HARDIN LLP, Patent Department, 6600 Sears Tower, 233 South Wacker Drive, Chicago, IL, 60606, US

(21) Appl. No.: 10/804,944

(22) Filed: Mar. 19, 2004

(30) Foreign Application Priority Data
Mar. 21, 2003 (DE) 103 13 863.3

(51) Int. Cl. H01J 35/08; G21K 1/00

(52) U.S. Cl. 378/161

(57) ABSTRACT

An x-ray beam emission window for vacuum tubes and Image Intensifiers, In particular for Megalix® tubes, has a beam-permeable plate and a metallic window frame supporting this plate that can be attached in a wall opening of the vacuum tube. The radiation-permeable plate is a ceramic disc, and the window frame into which the ceramic disc is soldered is formed of a metal adequate for accommodating ceramic expansion.

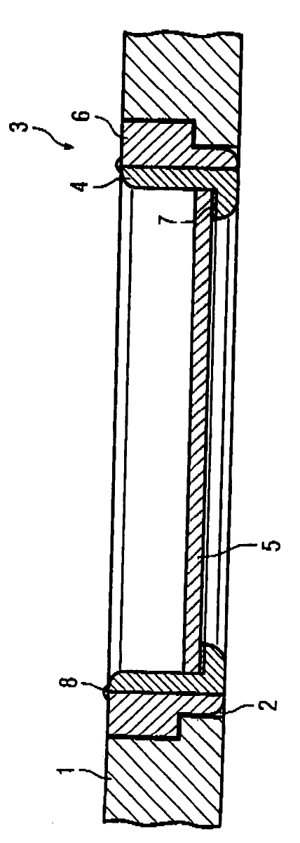

### BACKGROUND OF THE INVENTION

1. Field of the Invention

The present invention concerns an x-ray beam emission window for vacuum tubes and image intensifiers, in particular for Megalix® tubes, of the type having a beam-permeable plate and a metallic window frame supporting the plate that can be attached in a wall opening of the vacuum tube.

2. Description of the Prior Art

Typically, beryllium windows are used for purposes as described above. Beryllium, however cannot be mechanically worked nor soldered without particularly elaborate measures since it is highly toxic, and the processing devices themselves may subsequently no longer be used for other purposes. Additionally, the cost for disposal according to government regulations will continually rise in the future, since any kind of cutting of the window for removal is not allowed. Thus the entire tube must be disposed of in radiation-safe repositories, which represents an unacceptable cost in practice. For this reason, worldwide there are ever fewer providers worldwide for pre-finished beryllium windows, making their present day use highly problematical, and most likely such use will be precluded in the near future.

British Specification 2 023 921 concerns a dental x-ray device in which a ceramic x-ray beam window is directly soldered into the housing, which is very disadvantageous for various reasons, since in this manner the disposal of such a tube becomes much more difficult.

### SUMMARY OF THE INVENTION

An object of the present invention is to provide an x-ray beam emission window that can replace the conventional beryllium windows and that is significantly more advantageous in terms of finishing costs and disposal costs.

This object is achieved in accordance with the invention in a beam emission window having radiation-permeable plate that is a ceramic disc, and a window frame in which the ceramic disc is soldered that is composed of a metal suitable for (compatible with) the thermal expansion properties of the ceramic disc.

A very simple and cost-effective ceramic disc can be made from Al₂O₃ or SiC. Preferably window frames made from Vakon, particularly Vakon 10, can be used with these ceramic discs. Vakon has a composition of 27-30 Wt % Ni, 16-24 wt % Co, other <wt %, and a remainder Fe.

To solder the ceramic disc into the window frames, either the ceramic disc is first provided with a metallization in the solder area, such that it can subsequently be soldered into the window frame with normal solder, or instead an unmetallized ceramic disc can be used when active solder is used for soldering.

It has proven to be particularly convenient to solder the aforementioned window frame into an auxiliary frame, made of stainless steel and surrounding the window frame with a press fit, which, at one side, can be welded into the wall opening of the tube.

The vacuum tube can be an x-ray tube, in particular a rotating anode tube or an x-ray image intensifier.

### DESCRIPTION OF THE DRAWINGS

The FIGURE is a section through an exemplary embodiment of an inventive x-ray beam emission window.

### DESCRIPTION OF THE PREFERRED EMBODIMENTS

In the FIGURE, the middle part 1 of a vacuum tube (in particular a Megalix® tube) that can be composed of copper. Inserted into an insertion recess 2 is a window 3 that, in the exemplary embodiment, is a ceramic disc 5 soldered into a window frame 4 and an auxiliary frame 6, composed of stainless steel, surrounding the window frame 4.

The ceramic disc 5 is formed, for example, of Al₂O₃ or SiC and is soldered with a solder layer 7 into the window frame 4 that is comprised of a material adequate for ceramic expansion, such as Vakon 10. Given an untreated ceramic disc 5, the soldering ensues with active solder, or the soldering can ensue with normal solder given a metallization of the ceramic disc 5 in the solder area. The window frame 4 is surrounded by an auxiliary frame 6 (made of stainless steel) and soldered thereto at solder joint 8. Upon thermal expansion, the auxiliary frame 3 as well as the middle part 1 of the Megalix® tube expand significantly, such that a pressure loading on the ceramic disc 5 never ensues, but rather in all cases tensile forces occur, which can be absorbed without added measures as a result of the only one-sided solder joint 8 between the window frame 4 and the auxiliary frame 6.

The invention is not limited to the shown exemplary embodiment. It is not mandatory to provide the auxiliary frame 6, but this enables a simpler recycling of a Megalix® tube provided with such a window.

Although modifications and changes may be suggested by those skilled in the art, it is the intention of the inventors to embody within the patent warranted hereon all changes and modifications as reasonably and properly come within the scope of this contribution to the art.

We claim as our invention:

1. An x-ray beam emission window for vacuum tubes and image intensifiers comprising:
a radiation-permeable plate formed by a disc of ceramic material; and
a window frame supporting said plate and adapted for attachment in a wall opening of an evacuated housing, said window frame being composed of a metal compatible with thermal expansion properties of said ceramic material.

2. An x-ray beam emission window as claimed in claim 1 wherein said ceramic material is selected from the group consisting of Al₂O₃ and SiC, and wherein said window frame is composed of a metal selected from the group consisting of Vakon and Vakon 10.

3. An x-ray beam emission window as claimed in claim 1 wherein said plate has a metallization thereon and is soldered into said window frame with solder.

4. An x-ray beam emission window as claimed in claim wherein said plate is soldered into said window frame with active solder.

5. An x-ray beam emission window as claimed in claim 1 comprising an auxiliary frame composed of stainless steel and surrounding said window frame and adapted for welding into said wall opening of said evacuated housing.
